(19) United States
(12) Patent Application Publication
(10) Pub. No.: US 2016/0292607 A1
(43) Pub. Date: Oct. 6, 2016

(54) Utility Pole Staking System and Method

(71) Applicant: Marmon Utility LLC (Hendrix), Milford, NH (US)

(72) Inventor: Clay Schmick, Milford, NH (US)

(21) Appl. No.: 15/087,543

(22) Filed: Mar. 31, 2016

Related U.S. Application Data
(60) Provisional application No. 62/140,943, filed on Mar. 31, 2015.
(60) Provisional application No. 62/145,933, filed on Apr. 10, 2015.

(51) Int. Cl. G06Q 10/06; H04W 88/02

(52) U.S. Cl. CPC G06Q 10/06315; H04W 88/02

(57) ABSTRACT

Aspects of the invention include methods and systems for staking utility poles for a job. The methods and systems may comprise a central facility server; a network; and a mobile device adapted to transmit data to the central facility server using the network and including a processor and computer memory. The mobile device may be configured to: i) receive data for a circuit; ii) receive data regarding a plurality of poles for the circuit; iii) receive data regarding one or more assemblies for the poles of the circuit; iv) take and store photographs of the plurality of poles; v) receive notes for the job; vi) plot locations of the plurality of poles; vii) plot the circuit using the plotted locations for the plurality of poles; and viii) upload the data to the central facility server.

### RELATED APPLICATIONS

This application claims benefit of priority from U.S. Provisional Patent Application No. 62/140,943, filed Mar. 31, 2015 and U.S. Provisional Patent Application No. 62/145,933, filed Apr. 10, 2015. The entirety of all the above-listed applications are hereby incorporated herein by reference.

### FIELD OF THE INVENTION

The present invention generally relates generally to the utility industry and, in particular, to a utility pole staking system and method.

### BACKGROUND

In the utility industry, the term “staking” refers to documenting existing or defining new utility pole power distribution circuits. This includes capturing all utility pole data (everything on the pole or to be on the pole), global positioning (GPS) coordinates for each pole (pole plotting), images of the site and each pole, spans (distance between poles) and field notes. Typically this process is performed manually. A long form/sheet (staking sheet) is manually filled out for each pole and summarized as to needed material (Bill of Material). The GPS coordinates for each pole are taken and manually recorded. Performing this process manually typically takes an elapsed time of 2-3 weeks from “walk down” (site review) to proposal (cost of all material and services).

A need exists for a system and method that automates the utility pole staking process and integrates the data with circuit designs and proposals.

### SUMMARY OF THE INVENTION

The following presents a general summary of aspects of the invention in order to provide a basic understanding of the invention and various features of it. This summary is not intended to limit the scope of the invention in any way, but it simply provides a general overview and context for the more detailed description that follows.

According to aspects of this invention, a system for staking utility poles for a job may comprise a central facility server; a network; and a mobile device adapted to transmit data to the central facility server using the network and including a processor and computer memory. The mobile device may be configured to: i) receive data for a circuit; ii) receive data regarding a plurality of poles for the circuit; iii) receive data regarding one or more assemblies for the poles of the circuit; iv) take and store photographs of the plurality of poles; v) receive notes for the job; vi) plot locations of the plurality of poles; vii) plot the circuit using the plotted locations for the plurality of poles; and viii) upload the data to the central facility server. Additionally, the mobile device may be configured as a global positioning receiver and to use data received from a global positioning system to plot locations of the plurality of poles.

Additionally, another aspect of this invention may relate to a mobile device for staking utility poles for a job comprising a processor and computer memory that has been configured to: i) receive data for a circuit; ii) receive data regarding a plurality of poles for the circuit; iii) receive data regarding one or more assemblies for the poles of the circuit; iv) take and store photographs of the plurality of poles; v) receive notes for the job; vi) plot locations of the plurality of poles; vii) plot the circuit using the plotted locations for the plurality of poles; and viii) upload the data to a central facility server. Additionally, the processor and computer memory may be configured as a global positioning receiver and to use data received from a global positioning system to plot locations of the plurality of poles.

Additionally, another aspect of this invention may relate to a method for staking utility poles for a job comprising the steps of: a) providing a mobile device; b) receiving data for a circuit using the mobile device; c) receiving data regarding a plurality of poles for the circuit using the mobile device; d) receiving data regarding one or more assemblies for the poles of the circuit using the mobile device; e) taking and storing photographs of the plurality of poles using the mobile device; f) receiving notes for the job using the mobile device; g) plotting locations of the plurality of poles using global positioning system data and the mobile device; h) plotting the circuit using the plotted locations for the plurality of poles and the mobile device; and i) uploading the data from the mobile device to a central facility server. Additionally, the mobile device may be configured as a global positioning receiver and to use data received from a global positioning system to plot locations of the plurality of poles.

### BRIEF DESCRIPTION OF THE DRAWINGS

A more complete understanding of the present invention and certain advantages thereof may be acquired by referring to the following detailed description in consideration with the accompanying drawings, in which:

FIG. 1 is a flow diagram illustrating the data transmission and reception components in an embodiment of the invention;

FIG. 2 is an illustration of a Job screen displayed by a mobile device in an embodiment of the invention;

FIG. 3 is an illustration of a Job Circuits screen displayed by a mobile device in an embodiment of the invention;

FIG. 4 is a an illustration of the top portion of an initial Pole screen displayed by a mobile device in an embodiment of the invention;

FIG. 5 is an illustration of a populated Pole screen displayed by a mobile device in an embodiment of the invention;

FIGS. 6a and 6b are illustrations of an initial Assembly screen and a partially populated Assembly screen, respectively, displayed by a mobile device in an embodiment of the invention;

FIG. 7 is an illustration of a Pole Photos screen displayed by a mobile device in an embodiment of the invention;

FIG. 8 is an illustration of a pole photo taken using a mobile device in an embodiment of the invention;

FIG. 9 is an illustration of a listing of pole photos stored on a mobile device in an embodiment of the invention;

FIG. 10 is an illustration of a Pole Notes screen displayed by a mobile device in an embodiment of the invention;

FIG. 11 is an illustration of Job Site Summary screen displayed by a mobile device in an embodiment of the invention;

FIG. 12 is a flow diagram illustrating the reporting capability of an embodiment of the invention;

FIG. 13 is an illustration of a pole plotting screen displayed and printed by a mobile device in an embodiment of the invention;

FIG. 14a illustrates another embodiment of a home screen with local job storage functionality as displayed by a mobile device in an embodiment of the invention; and

FIG. 14b illustrates a saved jobs screen for the local job storage as displayed by a mobile device in an embodiment of the invention.

The reader is advised that the attached drawings are not necessarily drawn to scale.

### DETAILED DESCRIPTION OF EMBODIMENTS

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three dimensional orientation of structures in order to fall within the scope of this invention.

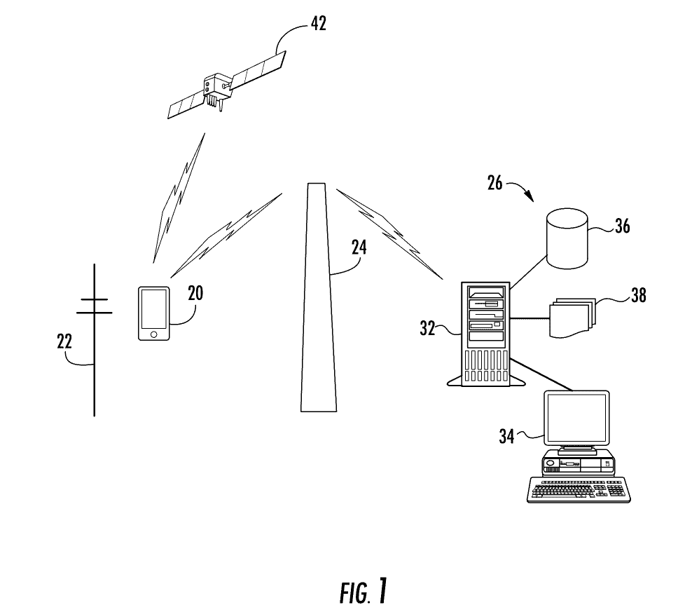

An embodiment of the system of the present invention is illustrated in FIG. 1. The system includes a mobile device 20, such as a smartphone, personal display device, personal data assistant, IPHONE, IPAD or the like that features a processor and computer memory and that has been loaded with an application with the functionality described below. The device is taken by a user to a job site where a power distribution circuit of utility poles 22 exists or where a new circuit is planned. As described below, staking is accomplished by the user entering data into the mobile device 20. This data is transmitted via a cellular network 24, or any other type of network, to a centralized facility or station 26 which features a computer or server 32 that is accessed via a workstation 34. The server has access to a data storage device 36 and, as described below, is configured to produce reports 38 (either electronically for email transmission or as hardcopies by a printer).

As described below, the mobile device 20 is also in communication with a global positioning system (GPS) satellite 42 for pole plotting and mapping functions.

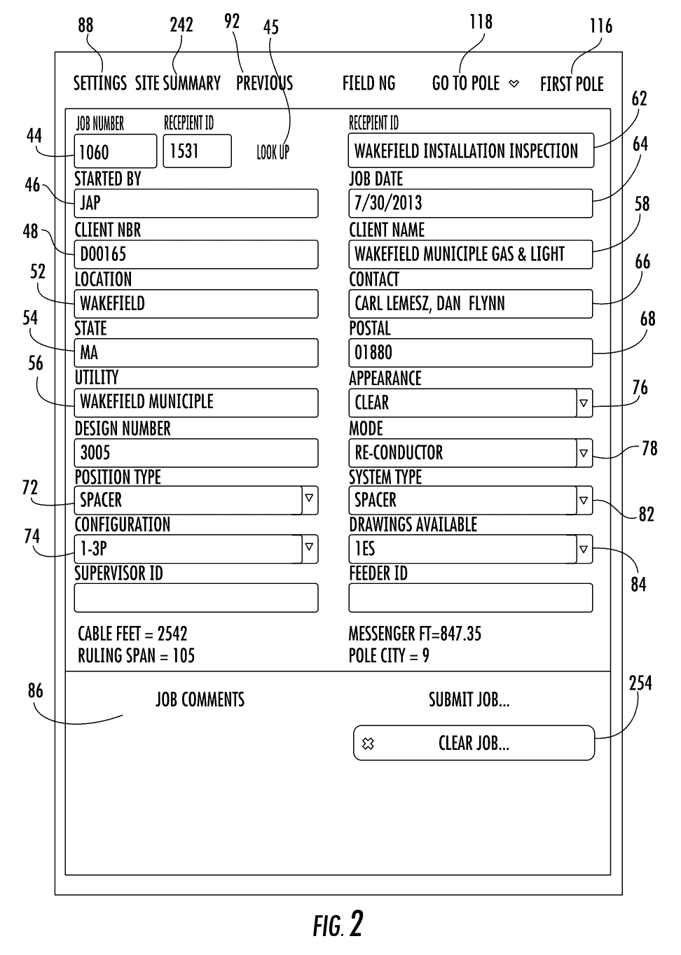

When the user accesses the application in an embodiment of the present invention, the Job screen of FIG. 2 is initially displayed on the mobile device 20 of FIG. 1 (after any application identification screens). If the user wishes to access a job that has already been created (and stored on data storage device 36 of FIG. 1), a job number is entered into field 44 on the screen of FIG. 2 and the Look Up icon 45 is selected. If the job was created previously, the remaining fields of the home screen are populated with data downloaded from the data storage device and server of FIG. 1.

It should be noted that the entries or selections described below and/or included in the figures for the fields of the illustrated screens are provided as examples only, and alternative entries or selections may be used.

If the user is creating a new job, he or she enters the information in the fields of the screen of FIG. 2 such as user's initials (46), the customer identification number (48), the town (52) and state (54) of the job and the name of the utility (56). The customer identification number (48) may automatically appear if the user instead first enters the customer's full name in field 58. The user also enters the job name (62), job date (64), customer contact (66) and zip code (68). In pulldown field Exiting Type 72, the user selects the appropriate entries to describe the existing power circuit installation. For example, pulldown field 72 may offer a selection between entries Bare, Non, Spacer, Tree or Underground. The Configuration field may offer choices between codes such as 1-1P, 1-2P, 1-3P, 2-3P, etc. A description of the ambient atmosphere of the job site may be entered via pulldown field 76, which may offer selections such as Clean, Clear, Costal, Desert, or Industrials. The job Mode is entered via pulldown field 78 and may include selections such as Additional Circuit, Backlot/Alleyway, Clearance, Distribution/Secondary, Ecological, Express Circuit, Industrial or Long Span. The System type for the job may be entered via pulldown field 82, and may include selections such as Bare, Spacer, Tree and Underground. The Trunk Access pulldown field 84 merely provides entries Yes and No. A screen that accepts text for entering notes is provided if the Job Comments icon 86 is selected.

The user selects the Settings tab 88 to provide an email address to which the application transmits data. The user can also view the status of a job upload after selecting the Settings tab.

The application provides three levels of data entry: (1) job site, (2) circuit and (3) pole. The job site may include a number of circuits, and each circuit includes a number of utility poles.

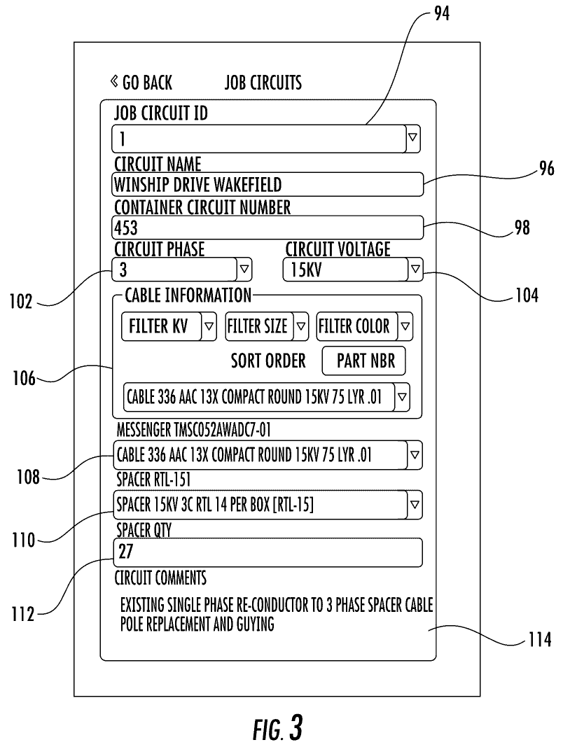

The Circuits tab 92 of the Job screen of FIG. 2 is displayed in green if information regarding circuits has been entered for the job. When the Circuits tab 92 of FIG. 2 is selected, the Circuits screen of FIG. 3 is displayed. The screen of FIG. 3 permits the user to enter circuit information (for a new job) including the Circuit Number (field 94), Circuit Name (96) and Customer Circuit Number (field 98). The Circuit Phases and Voltage are entered in fields 102 and 104, respectively. Information regarding cables used in the circuit (or planned for use in the circuit) is entered in pulldown fields 106, as are messenger (field 108) and spacer (field 110) selections. The number of cable spacers (in use or planned) for the circuit is entered into field 112. Circuit comments may be entered into field 114.

Once the job and circuit information is entered into the application, the user may enter pole information for each pole of each circuit. The user returns to the Job screen (FIG. 2) and selects the First Pole tab 116. If data for a number of poles has already been entered, the Go to Pole tab 118 will be present, and the user can select the data screen for a selected pole.

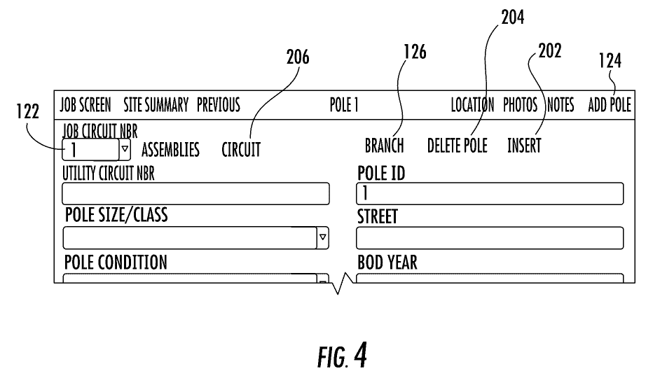

When the user selects tab 116 of the screen of FIG. 2, and no pole data has been previously entered, the screen of FIG. 4 (only the top portion illustrated) is presented on the mobile device. The Circuit number for which the pole is part of is displayed in field 122. After the data for Pole 1 is entered, as described below, the user may select the Add Pole tab 124 of FIG. 4, and a screen similar to the screen of FIG. 4 (except titled Pole 2) will appear. This cycle is repeated until data for all of the poles of the circuit have been entered.

When poles of a second, previously entered circuit (Circuits tab 92 of FIG. 2) need to be entered, the user may select circuit 2 using the Circuit Number pulldown 122 of FIG. 4, and select the Add Pole tab 124. The Pole 1 screen of FIG. 4 will then be displayed for the first pole of Circuit 2 (the number 2 will be displayed in field 122). The cycle of the above paragraph repeats for every pole in Circuit 2. Poles for additional circuits (i.e. circuit numbers 3, 4, 5. . . ) are added in a similar manner.

Returning to the example where the pole data for Circuit 1 needs to be entered, pole data entry screen of FIG. 4 permits the system to accommodate power distribution branches of a circuit. The user enters the branch number by selecting icon 126 of the screen of FIG. 4 and entering the circuit branch number. For example, circuit 1 may have branches 1A, 1B, 1C, etc.

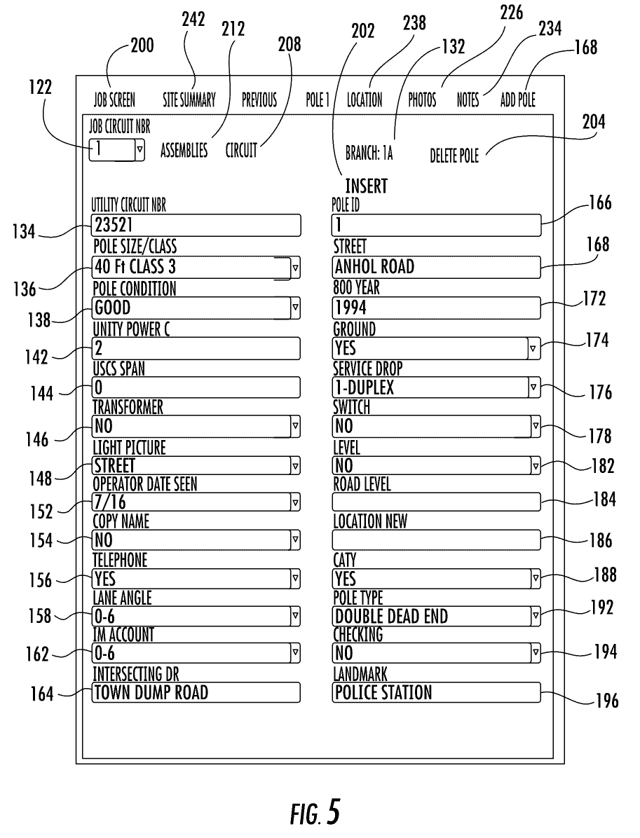

Pole data may then be entered for the circuit using the Pole screen of FIG. 5. More than one circuit (and thus circuit number) may be present on a pole. The circuit branch (if any) for the pole is indicated in field 132. The Utility Circuit Number may be entered in field 134. The Pole Size/Class is selected using pulldown field 136. For example, the pulldown field 136 may provide choices such as 30-foot class 4, 30-foot class 5, 35-foot class 4 and 35-foot class 5. A description for an existing or proposed pole is provided in pulldown field 138, which may include selections including Defective, Good, Install, New, Proposed or Retire. The utility pole ID and back span are entered in fields 142 and 144. Transformer information is entered into pulldown field 146, which may include selections 1, 2, 3, capacitor or No. The presence and type of light fixture on the pole is indicated in pulldown field 148, which may include selections Flood, No, Other (see notes), Security, Street, Traffic or Traffic and Street. The down guy cable size (such as ½, 10M, 20M, ¾, ⅜, etc.) is provided in pulldown field 152 and whether the guy cable is new (Yes or No) is indicated in pulldown field 154. The presence and type of telecommunications cable is provided in pulldown field 156 and may include selections such as No, Overhead Tap, Underground Tap or Yes. The line angle is entered in pulldown field 158 and may include selections <60, >60, 0, 0-6, 1-6, 10, 15, 20, 25, 30. Truck access for the pole (Yes or No) is noted in pulldown filed 162. The closest intersecting street for the street upon which to pole is located is entered in field 164.

Turning to the second column of the screen of FIG. 5, the Pole ID number appears in field 166. The street upon which the pole is located (or closest street) is entered into field 168, which the BOD Year is entered into field 172. Pulldown fields are provided for whether the pole is grounded (field 174, Yes or No), service drop (field 175, 1-Duplex, for example), the switch type on the pole or whether there is one (field 178, selections may be Gang, Horizontal, No, Recloser, Under Arm or Vertical) and whether there is a riser (field 182, Yes or No). If there is a guy wire, the guy wire load footage is entered into field 184. A location number, if any, is entered into field 186. Pulldown fields are provided to indicate whether there is a cable TV cable on the pole (field 188 where selections may be No, Overhead Tap, Underground Tap or Yes), the pole type (field 192 where selections may be Angle<60, Angle>60, Dead End, Double Dead End, Pole Top Extension, Spare, Switch, Tangent, Tap) and whether the pole is located at any type of geographic crossing (field 194 where selections may be Highway, No, Other, Rail, Road or Water). Field 196 permits the entry of any nearby landmark.

Data for the next pole of the circuit is entered by selecting the Next Pole tab 198 at the top of the screen of FIG. 5. The next pole will be on the same street (field 168) as the previous pole. The user may return to the Job screen (FIG. 2) by selecting the Job screen tab 200.

Additional branches may be added by selecting the Insert icon (202 in FIGS. 4 and 5). A pole may be deleted by selecting the Delete icon (204 in FIGS. 4 and 5). The Circuit icon 206 of the screen of FIG. 4 permits the user to indicate the type of circuit: Normal, Tap, Split or Transition. If Tap or Split is selected, an icon 208 appears indicating same to permit entry and view of related information.

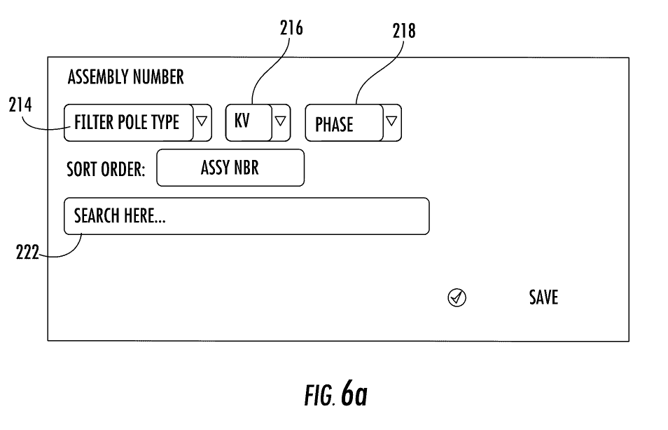

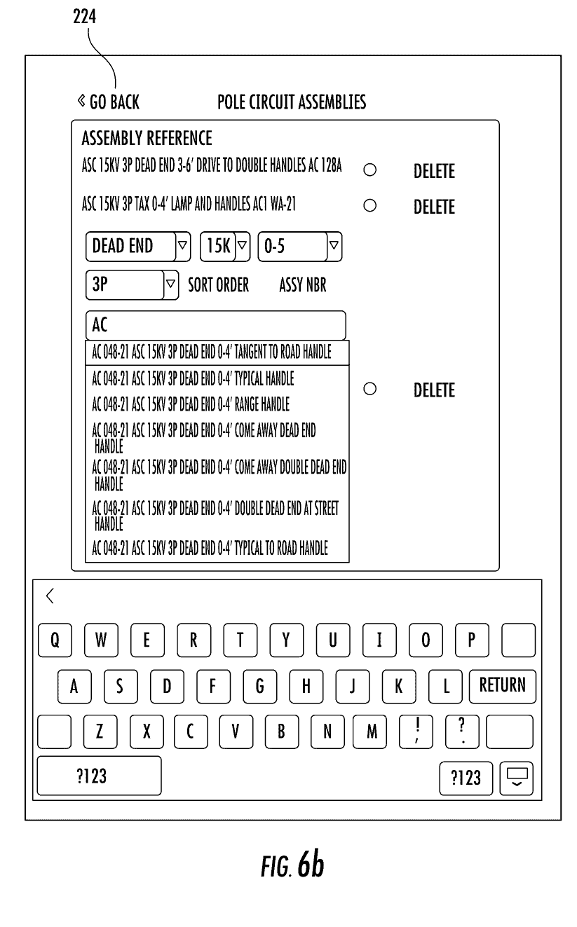

The Assemblies icon 212 of the screen of FIG. 5 enables the user to enter information regarding the pole assemblies. When the Assemblies icon is selected, the screen of FIG. 6a is presented to the user who may then select the Filter pole type, kV and Phase using pulldown fields 214, 216 and 218 of FIG. 6a, respectively. The user may search for an assembly number using the search field 222 (as illustrated in FIG. 6b). The user then may return to the Pole screen of FIG. 5 by selecting the Go Back tab 224 of FIG. 6b.

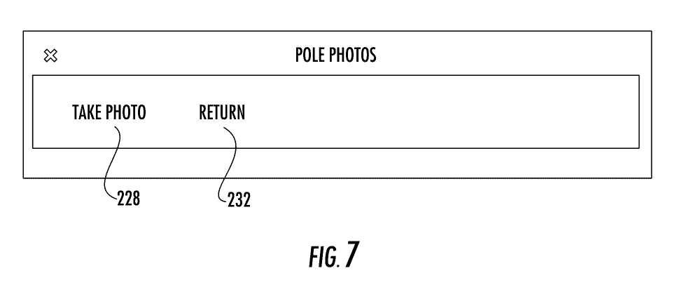

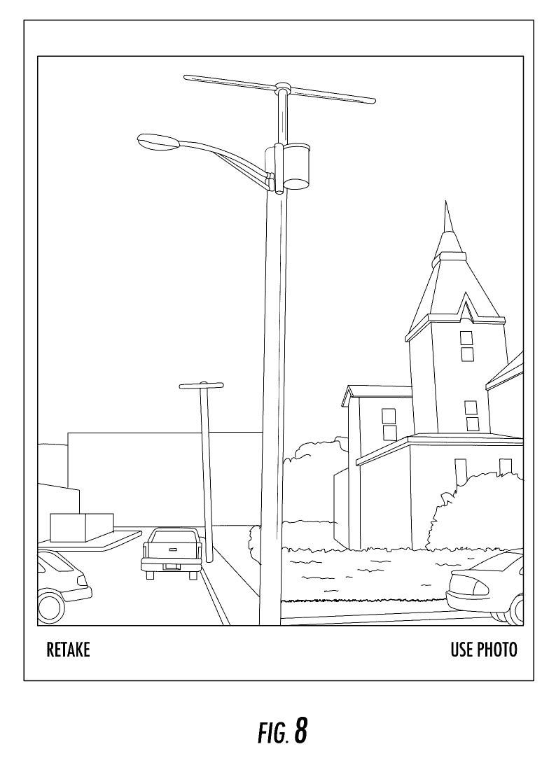

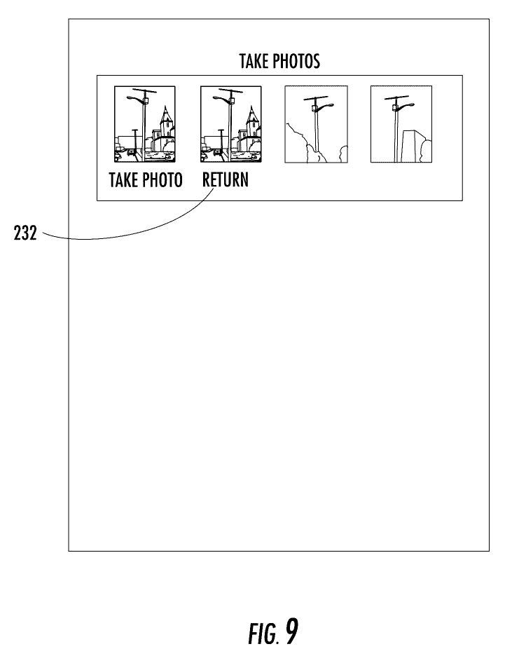

After the information/data is collected for a pole, the user may take a photograph of the pole by selecting the Photos tab 226 of the screen of FIG. 5. When this action is taken, the screen of FIG. 7 appears and the user may take a photo of the pole (FIG. 8) by pointing the mobile device at the pole and selecting the Take Photo icon 228. As illustrated in FIG. 9, the user may opt to take multiple pictures of the same pole, all of which are stored by the application. The user then return to the Pole screen of FIG. 5 by selecting the Return icon 232 of the screen of FIGS. 7 and 9. Once photo data has been entered for the pole, the Photos tab 226 of FIG. 5 appears in green to indicate the presence of photo data.

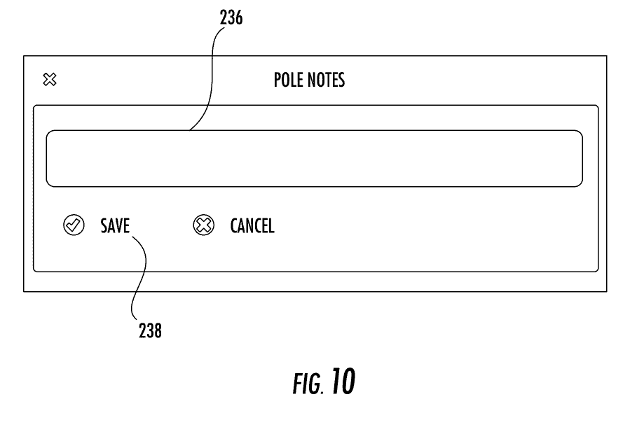

Any notes for the pole may be entered by selecting the Notes tab 234 of FIG. 5, where screen 10 will be presented as a result. The user may type his or her notes into the field 236 of the screen of FIG. 10 and select the Save icon 238 to save them and return to the Pole screen of FIG. 5. All field notes may be incorporated in the drawings and other output produced by the system.

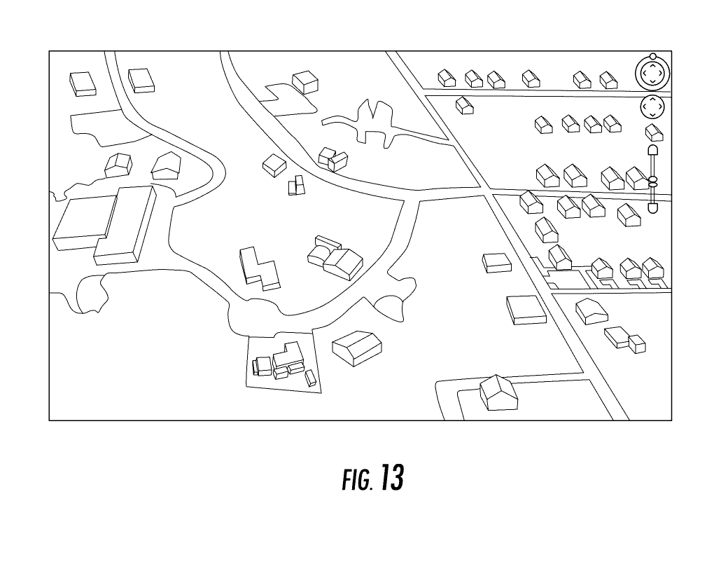

As illustrated in FIG. 1, the mobile device 20 is also configured as a GPS receiver and communicates with a GPS satellite 42. The user may plot or map the location of the pole by placing the mobile device next to the utility pole (22 of FIG. 1) and selecting the Location tab 238 of the screen of FIG. 5. This starts the pole plotter feature of the application on the mobile device and causes the location of the pole to be recorded via GPS so that it may be viewed using a mapping or plotting application or software such as GOOGLE EARTH. More specifically, as illustrated in FIG. 13, the pole location may be indicated with a “pin” on GOOGLE EARTH with multiple poles/pins joined by connecting lines by the pole plotter of the application to illustrate the circuit(s). The Locations tab 238 of the Pole screen of FIG. 5 is shown in green after the location data is captured for a pole.

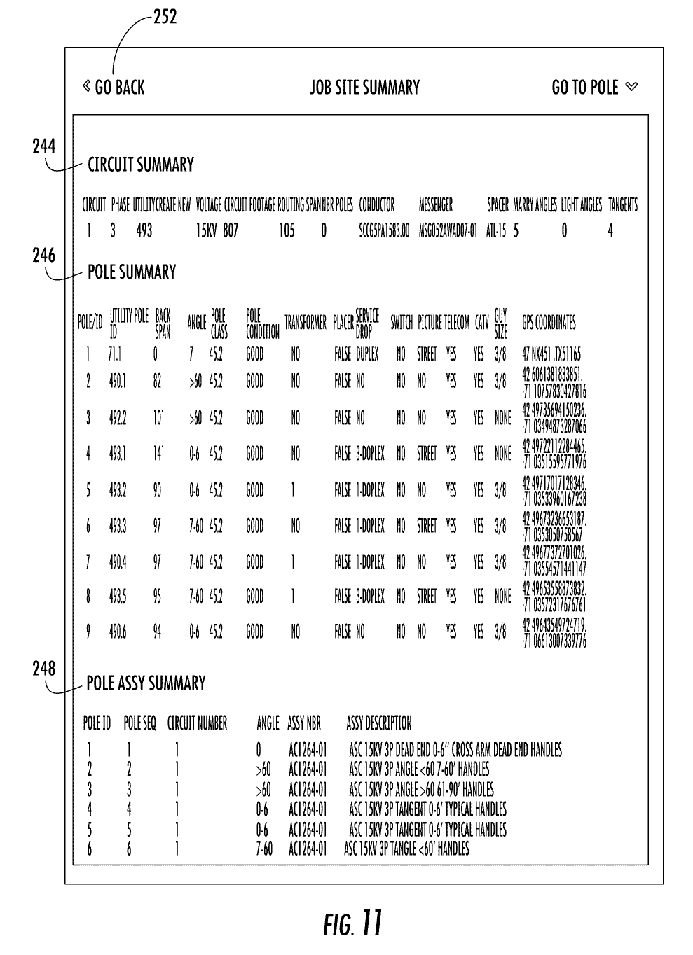

Once the all pole and circuit data for a job has been entered, the Site Summary tab 242 of the screens of FIG. 2 or 5 may be selected by the user to display the Job Site Summary screen of FIG. 11. This screen provides a summary of the circuit data 244, pole data 246 and pole assembly data 248 entered so that the user can check his work for errors. If everything appears to be in order, the user selects the Go Back icon 252 to return to the Job screen of FIG. 2. The user may then submit or upload the job data by selecting the Submit Job icon 254 of the screen of FIG. 2. As a result, with reference to FIG. 1, the job data is transmitted to the central facility server 32 for processing and storage on data storage device 36.

With regard to the transmission of the job data to the central facility, the data preferably uploads via a cellular connection, but the large content such as images and video waits for a WIFI connection. Large content is deposited on cloud storage (such as a Dropbox). A notification email is sent to the central facility. All images, video file names are preferably stamped with the Pole Number, date and time.

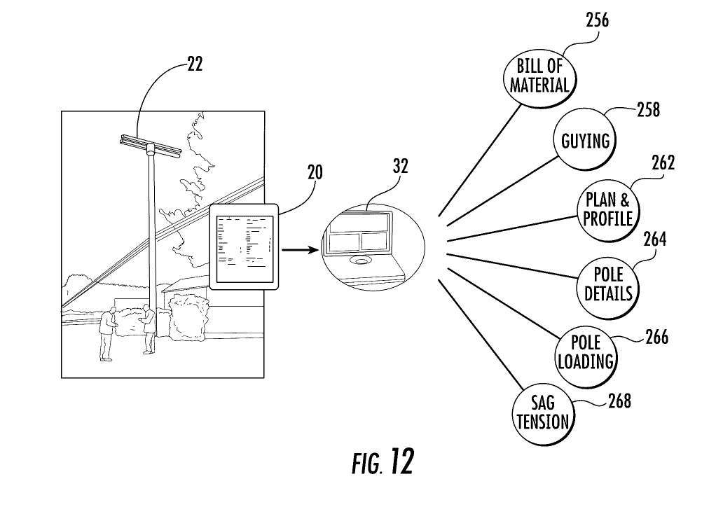

As illustrated in FIG. 12, server 32 may use the data provided from the remote device 20 to produce a number of reports and other output such as a Bill of Material 256 for the job, Guying information for proposed or existing poles 258, a Plan and Profile for the job 262, Pole Details for the job, Pole Loading reports 266 and Sag-Tension reports 268. Of course, this information, as well as a plot of the circuits (FIG. 13) may be displayed on the workstation (34 of FIG. 1) or printed as hardcopies (38 of FIG. 1).

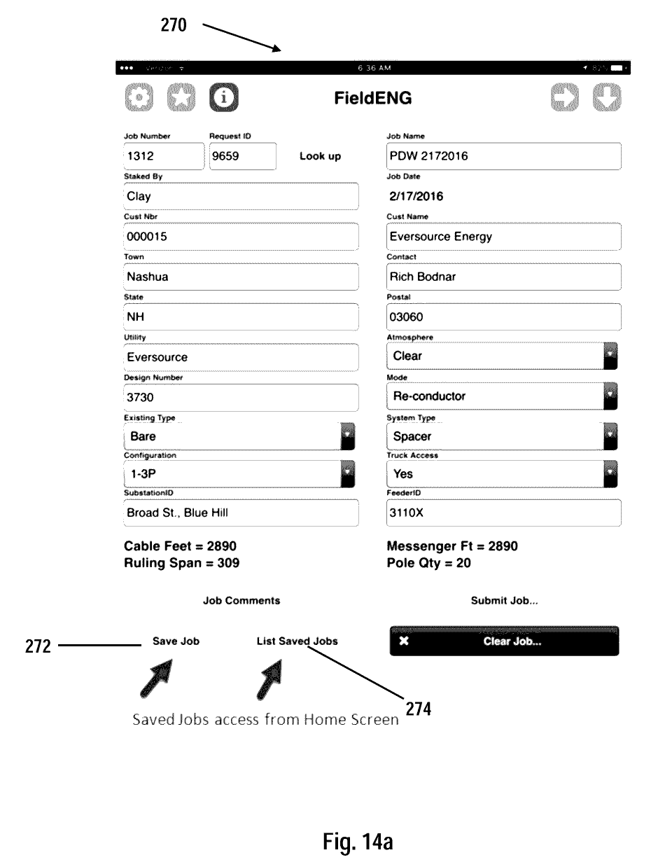

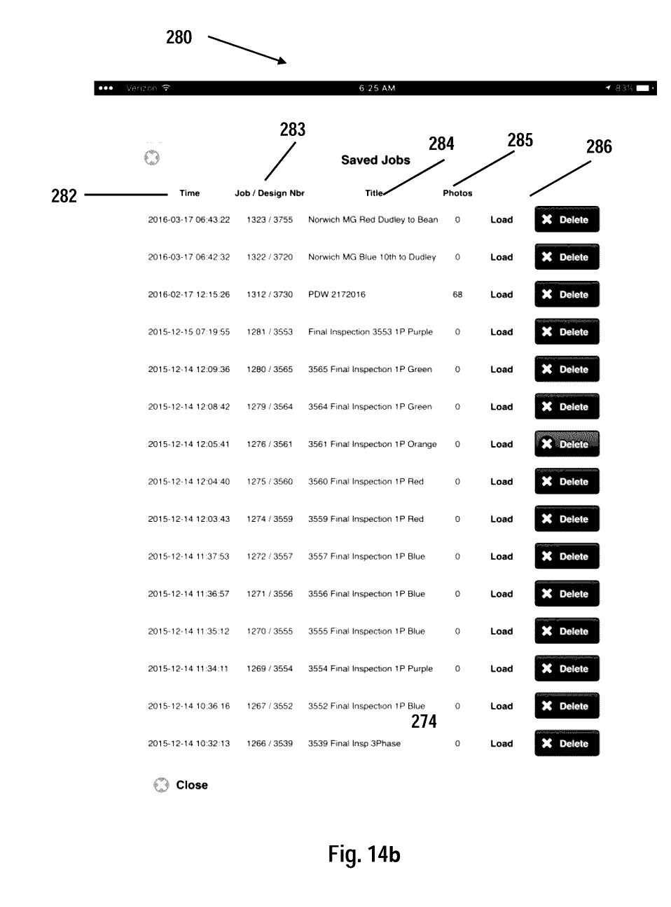

As illustrated in FIGS. 14a and 14b, a function to conduct local job storage with Save, Store, and Load Jobs may be utilized without departing from this invention. FIG. 14a illustrates a home screen 270 with local job storage functionality. As illustrated in FIG. 14a, the home screen may include two additional buttons, a Save Job button 272 and a List Saved Jobs button 274. A user may press the Save Job button 272 when they want to save a job to the a local file storage to access on the mobile device at a later point. A user may press the List Saved Jobs button 274 to view a list of the saved jobs. When a user presses the List Saved Jobs button 274, FIG. 14b illustrates a saved jobs screen 280 for the local job storage. As illustrated in the saved jobs screen 280, there may be columns for time of saved job 282, job number/design number 283, job title 284, number of photos with job 285, and a load/delete function buttons 286. This local job storage functionality may involve setting up local file storage and access on the mobile device. These features allow the user the ability to download multiple Jobs from the server, to Save Jobs in progress, and move from one Job to another without access to the server. There may be many benefits to these features, such as: setting up a series of Jobs before heading into the Field; complete a series of Jobs without having to upload (this can be helpful when multiple Jobs are done same day or in remote locations where WIFI signal is weak or nonexistent); the user submits partial Jobs with images without having to re-download the Job; the user is moving back and forth from Job to Job when a current Job cannot be completed due to weather or other constraints outside the users control.

Additionally, in another embodiment, the application may data management/file queue functionality. For example, the pole data and GPS locations may be sent over a cellular network as those data can be sent fast and with a small foot print and any image captures may be sent over a wireless (WIFI) network as those data are large foot print data. This data management/file queue feature will help conserve the user's cellular plan. Additionally, the data management/file queue feature may include data error tracking, such that should anything go wrong with the data upload or as triggered by the user, an error log may be transmitted.

Embodiments of the present invention therefore can reduce the pole staking process time from an elapsed time of two to three weeks (from walk down/site review to proposal/cost of all material and services) to two to three days. Embodiments of the present invention also electronically integrate the pole staking information so that reports, drawings, maps and other system output may be quickly and easily produced.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

What is claimed is:

1. A system for staking utility poles for a job comprising:
a central facility server;
a network;
a mobile device adapted to transmit data to the central facility server using the network and including a processor and computer memory, said mobile device configured to:
i) receive data for a circuit;
ii) receive data regarding a plurality of poles for the circuit;
iii) receive data regarding one or more assemblies for the poles of the circuit;
iv) take and store photographs of the plurality of poles;
v) receive notes for the job;
vi) plot locations of the plurality of poles;
vii) plot the circuit using the plotted locations for the plurality of poles; and
viii) upload the data to the central facility server.

2. The system of claim 1 wherein the mobile device is configured as a global positioning receiver and to use data received from a global positioning system to plot locations of the plurality of poles.

3. The system of claim 1 wherein the network is a cellular phone network.

4. The system of claim 1 wherein the mobile device is a smartphone.

5. A mobile device for staking utility poles for a job comprising a processor and computer memory that has been configured to:
i) receive data for a circuit;
ii) receive data regarding a plurality of poles for the circuit;
iii) receive data regarding one or more assemblies for the poles of the circuit;
iv) take and store photographs of the plurality of poles;
v) receive notes for the job;
vi) plot locations of the plurality of poles;
vii) plot the circuit using the plotted locations for the plurality of poles; and
viii) upload the data to a central facility server.

6. The mobile device of claim 5 wherein the processor and computer memory has been configured as a global positioning receiver and to use data received from a global positioning system to plot locations of the plurality of poles.

7. A method for staking utility poles for a job comprising the steps of:
a) providing a mobile device;
b) receiving data for a circuit using the mobile device;
c) receiving data regarding a plurality of poles for the circuit using the mobile device;
d) receiving data regarding one or more assemblies for the poles of the circuit using the mobile device;
e) taking and storing photographs of the plurality of poles using the mobile device;
f) receiving notes for the job using the mobile device;
g) plotting locations of the plurality of poles using global positioning system data and the mobile device;
h) plotting the circuit using the plotted locations for the plurality of poles and the mobile device; and
i) uploading the data from the mobile device to a central facility server.

8. The method of claim 7 wherein the mobile device is configured as a global positioning receiver and to use data received from a global positioning system to plot locations of the plurality of poles.

9. The method of claim 7, wherein the mobile device is adapted to transmit data to the central facility server using a network and including a processor and computer memory.

10. The method of claim 9 wherein the network is a cellular phone network.

11. The system of claim 7 wherein the mobile device is a smartphone.
